(19) United States
(12) Patent Application Publication
(10) Pub. No.: US 2013/0239585 A1
(43) Pub. Date: Sep. 19, 2013

(54) TANGENTIAL FLOW DUCT WITH FULL ANNULAR EXIT COMPONENT

(71) Applicant: Jay A. Morrison, Titusville, FL (US)

(72) Inventor: Jay A. Morrison, Titusville, FL (US)

(21) Appl. No.: 13/419,603

(22) Filed: Mar. 14, 2012

(51) Int. Cl. F23R 3/02; F02C 7/00

(52) U.S. Cl. 60/805

(57) ABSTRACT

An arrangement (100) for delivering combustions gas from a plurality of combustors onto a first row of turbine blades along respective straight gas flow paths, including: a hoop structure (104) at a downstream end of the arrangement and defining at least part of an annular chamber (24); and a plurality of discrete ducts (102), each disposed between a respective combustor and the hoop structure (104). Each duct (102) is secured to the hoop structure (104) at a respective duct joint (116). The hoop structure (104) includes a quantity of hoop segments (105, 130, 132) that is less than a quantity of ducts (102).

### STATEMENT REGARDING FEDERALLY SPONSORED DEVELOPMENT

Development for this invention was supported in part by Contract No. DE-FC26-05NT42644, awarded by the United States Department of Energy. Accordingly, the United States Government may have certain rights in this invention.

### FIELD OF THE INVENTION

The invention relates to a flow duct assembly for combustions gasses generated by combustor cans in a gas turbine engine. In particular, this invention relates to an assembly with discrete flow paths configured to receive discrete combustion gas flows from each combustor, where the discrete flow paths merge into a full annular exit component configured to unite the discrete combustion gas flows, where a construction of the full annular exit component is independent of a number of the discrete flow paths.

### BACKGROUND OF THE INVENTION

Various emerging designs for flow duct assemblies direct discrete flows of combustion gases from a respective can of a can annular combustor toward the first row of turbine blades. In conventional can annular gas turbine engines, a first row of turbine vanes properly orients and accelerates the combustion gases for delivery onto the first row of turbine blades. However, some of the emerging designs utilize a geometry of the flow duct assembly to properly orient and accelerate the discrete combustion gas flows, which obviates the need for a first row of turbine vanes. In some of these emerging designs without first row vanes the flow duct assemblies include a plurality of discrete gas flow ducts and a common duct structure, where one duct is associated with a respective can combustor and where all of the ducts lead to the common duct structure which is in turn disposed immediately upstream of the first row of turbine blades.

### BRIEF DESCRIPTION OF THE DRAWINGS

The invention is explained in the following description in view of the drawings that show:

FIG. 1 is a prior art subassembly of a flow duct assembly

FIG. 2 is an embodiment of the flow duct assembly

FIG. 3 is an alternate embodiment of the flow duct assembly of FIG. 2.

FIG. 4 is an alternate embodiment of the flow duct assembly.

FIG. 5 is an alternate embodiment of the flow duct assembly of FIG. 4.

### DETAILED DESCRIPTION OF THE INVENTION

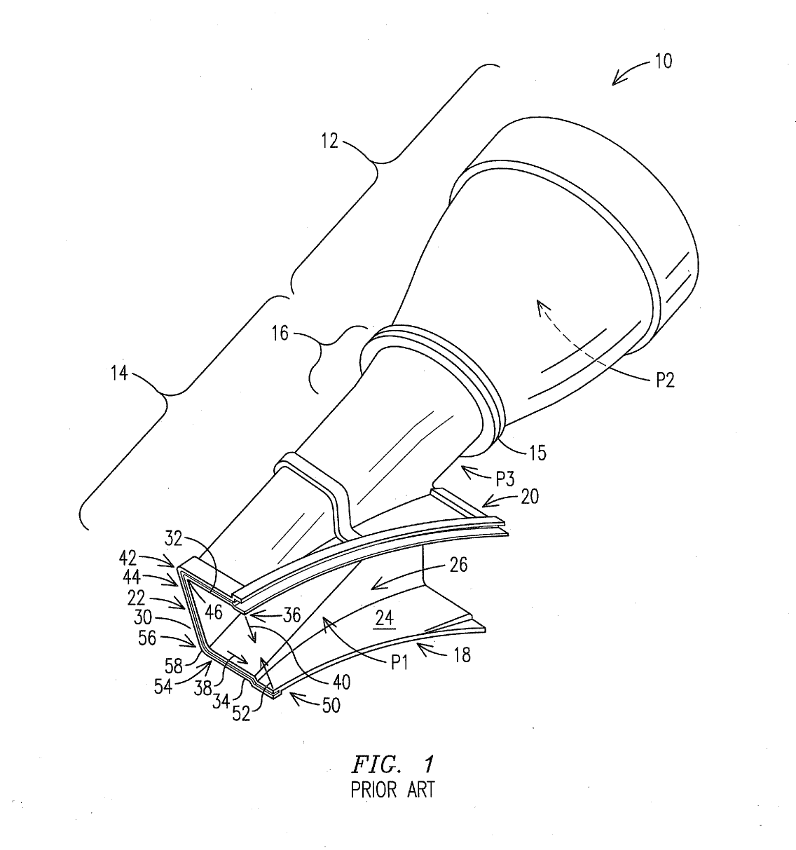

The present inventor has recognized that flow duct assemblies that accelerate combustion gases to a speed appropriate for delivery onto the first row of turbine blades incur substantially more mechanical loads than do conventional transition ducts. This is due to a greater difference in static pressure of compressed air outside of the flow duct assembly than a static pressure of the combustion gases inside the flow duct assembly. In conventional gas turbine transition ducts leading from a can combustor to a first row vane, combustion gases may enter the transition duct at, for example, approximately 0.2 mach and may leave the transition duct at, for example, approximately 0.3 mach. Within the first row vane assembly the combustion gases are subsequently accelerated to a speed appropriate for delivery onto a first row of turbine blades, which may be, for example, approximately 0.8 mach. However, in the emerging designs for flow duct assemblies where no first row of vane assembly is used, in order to properly accelerate the combustion gases for delivery onto the first row of turbine blades the flow duct assembly itself must accelerate the combustion gases from approximately 0.2 mach to approximately 0.8 mach. Since it is known that as a fluid accelerates it will exhibit a decreasing static pressure, (everything else remaining the same), within the flow duct assembly in a region of accelerated combustion gases, (the accelerated region), the accelerated combustion gases will exhibit a much lower static pressure. Consequently, a static pressure difference between the compressed air outside of the assembly and the combustion gases in the accelerated region will be much greater than any pressure difference present in a convention transition duct. This relatively large pressure will manifest as a greater mechanical load on the flow duct assemblies than is present on traditional transition ducts. This greater mechanical load will occur from a point in the flow duct assemblies at which and downstream of where the acceleration of the combustion gases occurs. In one embodiment (see FIG. 1) a common duct structure will experience the greater mechanical load since it is at a downstream end of the flow duct assembly and combustion gases traveling there through have already been accelerated significantly. Further, these increased pressure loads then require complicated support structure and thickened side flanges. In addition to the mechanical loads, there are thermal loads resulting from the complex geometry and the differences in thermal loading.

The present inventor has also recognized that these increased mechanical and thermal loads may result in a loss of efficiency when used in flow duct assemblies designed using assembly techniques associated with individual transition ducts typically used in gas turbine engines using can annular combustors. Specifically, since the assembly techniques used with individual transition ducts were never meant to withstand the increased mechanical loads that the emerging flow duct assemblies must withstand, there are previously unrecognized inadequacies present in the assembly techniques associated with conventional transition ducts when applied to the emerging flow duct assembly designs.

Similarly, annular combustors are comparable to conventional transition ducts in that the annular combustors have not been designed to accelerate the combustion gases because they also rely on the first row of vanes to accelerate the combustion gases. Accordingly, they were not designed to accommodate the increased mechanical loads and therefore their designs also suffer from previously unrecognized inadequacies when applied to the emerging flow duct assembly designs.

As a result of this recognition the inventor has created a flow duct assembly that does not suffer from the same inadequacies associated with prior flow duct assembly designs. In particular, in contrast to the prior art assembly techniques, where the flow duct assembly may include as many subassemblies as there are combustors, all bolted together circumferentially to form the flow duct assembly, the present invention provides for the common duct assembly to be made up of a hoop structure, where the hoop structure includes as few as one hoop structure component. In certain emerging flow duct assembly designs the common duct assembly may form an annular chamber where the discrete combustion gas flows may unite prior to delivery onto the first row of turbine blade.

The inventor has further recognized that in some cases it may be advantageous to separate portions of the flow duct assembly. For example, those portions that define an outer portion of the flow duct assembly may be separated from those portions that define an inner portion of the flow duct assembly. In a typical turbine, inner support structures may support the inner portion of the flow duct assembly, while outer support structures may support the outer portion of the flow duct assembly. However, thermal grown of the inner support structure may be different than thermal growth of the outer support structure, resulting in relative displacement between the two. If the flow duct assembly is rigid, relative movement of the supports attached to the flow duct assembly may cause stresses in the supports and/or the flow duct assembly. Further, due to their different locations, there may be relative thermal growth between the inner portion of the flow duct assembly and a outer portion may themselves grow at different rates than each other and thereby generate thermally induced stresses. To alleviate this, the inventor has developed an embodiment of the flow duct assembly where the inner portion and the outer portion are connected to each other via a less rigid connection which can accommodate the relative displacement without generating excessive stresses.

As seen in FIG. 1, a subassembly 10 of the prior art flow duct assembly may include a cone 12 and an integrated exit piece (IEP) 14 connected to the cone 12 at cone/IEP joint 15. The integrated exit piece may include several features. One feature is a throat region 16 that may serve any or all of several functions, including: collimating a combustion gas flow entering the throat region; transitioning a cross section of the combustion gas flow entering the throat region 16 from circular to more of a quadrilateral shape with rounded corners when exiting; and further accelerating the combustion gasses in addition to an acceleration that occurs within the cone section. Another feature may be an annular chamber segment 18. When all of the subassemblies 10 are assembled into the prior art flow duct the annular chamber segments 18 together form an annular chamber. If it takes, for example, twelve subassemblies to form the prior art flow duct assembly, then each annular chamber segment 18 forms a portion 24 of the annular chamber that equates to 1/12 of the annular chamber.

Each annular chamber segment 18 has a circumferentially upstream end 20 and a circumferentially downstream end 22, with respect to a circumferential direction 26 of flow of combustion gasses within the annular chamber. Since combustion gases exiting the annular chamber, and therefore the annular chamber portion 24, have been accelerated to approximately 0.8 mach, a static pressure P1 of the accelerated combustion gasses in the annular chamber portion 24 is less than a static pressure P2 of the combustion gases within the cone traveling at approximately 0.2 mach. In turn, the static pressure P2 of the combustion gases in the cone is less than a static pressure P3 of compressed air surrounding the prior art flow duct assembly and subassembly 10. (P1<P2<P3.)

Each annular chamber segment 18 includes a segment axially upstream wall 30, (with respect to an axial direction 38 of travel of combustion gases within the annular chamber segment 18), a segment radially outer wall 32, and a segment radially inner wall 34. The segment upstream wall 30 forms a portion of the annular chamber upstream wall. The segment radially outer wall 32 forms a portion of the annular chamber radially outer wall. Similarly, the segment radially inner wall 34 forms a portion of the annular chamber radially inner wall. It can be seen that each of these segment walls 30, 32, 34 separates a region of relatively high static pressure P3 from a region of relatively low static pressure P1.

As a result of the pressure difference, and the open ended geometry of the annular chamber segment 18, (and hence of the annular chamber), the segment radially outer wall 32 and segment radially inner wall 34 will be urged toward the region of relatively low pressure P1. In the prior art embodiment shown, this may result in a situation where an axial downstream end 36 of the segment radially outer wall 32 is urged radially inwardly as shown by arrow 40. An upstream end 42 of the segment radially outer wall 33, however, is fixed to the segment upstream wall 30 at a radially outer end 44 of the segment upstream wall 30. This may create mechanical stresses the two segment walls 30, 32, because the segment upstream wall 30 acts similar to a moment arm about an intersection 46 of the segment upstream wall 30 and the segment radially outer wall 32. Similarly, an axial downstream end 50 of the segment radially inner wall 34, may be urged radially outward as shown by arrow 52. Since an upstream end 54 of the segment radially inner wall 34 is fixed to the segment upstream wall 30 at a radially inner end 56, the segment radially inner wall 34 may also act similar to a moment arm about an intersection 58 of the segment radially inner wall 34 and the segment upstream wall 30. This may also create mechanical stresses the two segment walls 30, 34.

Under conventional transition duct methodology, where any pressure difference P1:P3 was not as great, it was thought that the subassemblies 10 could simply be joined together to create the flow duct assembly. Specifically, it was thought that a downstream end 22 of one subassembly 10 could be bolted, pinned, or otherwise conventionally joined to the upstream end 20 of a circumferentially downstream adjacent subassembly 10. This was repeated for each subassembly 10 until the flow duct assembly was formed. However, modeling, testing and experimentation have informed designers that the pressure difference is so great that using these conventional joining techniques may result in shortened life of the flow duct assembly, and under certain circumstances may not be sufficiently strong to withstand the mechanical forces induced by the pressure differences P1:P3. The pressure difference is so great that in some embodiments it is believed that despite being joined to adjacent subassemblies 10 the downstream end 36 of the segment radially outer wall 32 and the downstream end 50 of the segment radially inner wall 34 may yield to the point where they would buckle and possibly meet each other.

The inventor has recognized that this failure may be due at least in part to the conventional joining techniques being used. These conventional joining techniques were in accord with conventional combustor design ideologies where it is preferred to have modular designs so when maintenance is required, a single subassembly 10 requiring maintenance could be removed from the combustor through a small opening in the combustor casing. The conventional joining of subassemblies 10 permits this and this greatly simplifies maintenance because it eliminates the need to remove the engine casing, which can be expensive and time consuming, in order to perform this maintenance.

In addition to potentially not providing adequate structural support the inventor has recognized other drawbacks associated with the traditional joining techniques. For example, since each joint provides a leakage path, having a joint at each subassembly 10 would decrease engine efficiency since more air would leak. Further, machining the individual components, and in particular the IEP portion, is difficult and time consuming, and the geometry of the IEP portion makes it difficult to properly apply a thermal barrier coating (TBC). The hoop structure of the present invention is stronger, provides fewer leakage paths, and is easier to manufacture.

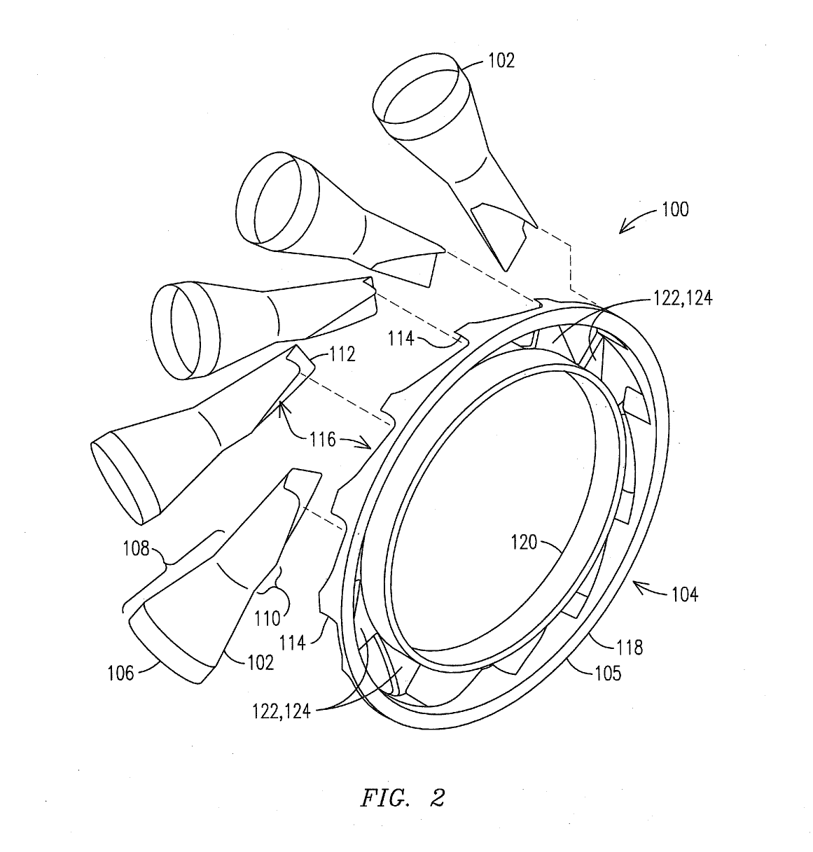

FIG. 2 shows an embodiment of the present invention where the flow duct assembly 100 includes one inlet cone 102 for each combustor (not shown) and the hoop structure 104 made of a single hoop segment 105. The inlet cone 102 includes an inlet end 106 configured to receive combustion gases from a respective combustor can, an acceleration region 108 indicated generally in which all of the acceleration of the combustion gases occurs, and a throat region 110 indicated generally, where the combustion gases may be collimated, the cross section reshaped, and where a portion of the acceleration may occur.

Each inlet cone 102 also includes an outlet 112 configured to deliver the received combustion gases to the hoop structure 104. The annular hoop structure 104 shares a common axis with the rotor (not shown) of the gas turbine engine. The inlet cone outlet 112 meets a respective hoop structure inlet 114 and form an inlet cone/hoop structure joint 116 (indicated generally in FIG. 2 though the mating components are spaced apart). A construction of the inlet cone/hoop structure joint 116 may take any form known to those of ordinary skill in the art. For example, there may be fasteners such as bolts, flanges, pins etc. Alternately, the inlet cones 102 may even be welded to the hoop structure 104. A welded assembly would provide good mechanical resistance to pressure induced loads, but it would be less effective with respect to thermal isolation of the components. Also visible in FIG. 2 is a location of the throat region 110, which in this embodiment is disposed in the inlet cone 102 upstream of the inlet cone/hoop structure joint 116, while the throat region 16 of FIG. 1 is disposed in the IEP, which is downstream of the cone/IEP joint 15.

The hoop structure 104 in this embodiment includes a radially outer wall 118, a radially inner wall 120, both sharing a common axis with the gas turbine engine rotor (not shown), and upstream wall segments 122. In this embodiment the radially outer wall 118 and the radially inner wall 120 are connected by the upstream wall segments 122. Thus, the upstream wall segments 122 thus form a non continuous upstream wall 124, where upstream wall segments 122 are disposed between respective hoop structure inlets 114. Since both the radially outer wall 118 and the radially inner wall 120 are continuous, single-piece hoop-shaped components, stresses resulting from the pressure difference P1:P3 manifest as a much more uniform hoop stress in each of the walls 118, 120, as opposed to the moment arm of the conventional assembly techniques. Hoop stress resulting from the pressure difference P1:P3 in a hoop shaped component is much less detrimental to the hoop shaped component than is the moment arm/cantilever type stress of the conventional design. Consequently, the hoop structure disclosed herein redistributes stresses in a more manageable manner and this redistribution overcomes the newly discovered weaknesses in the conventional joining techniques when applied to the newly emerging flow duct assembly designs.

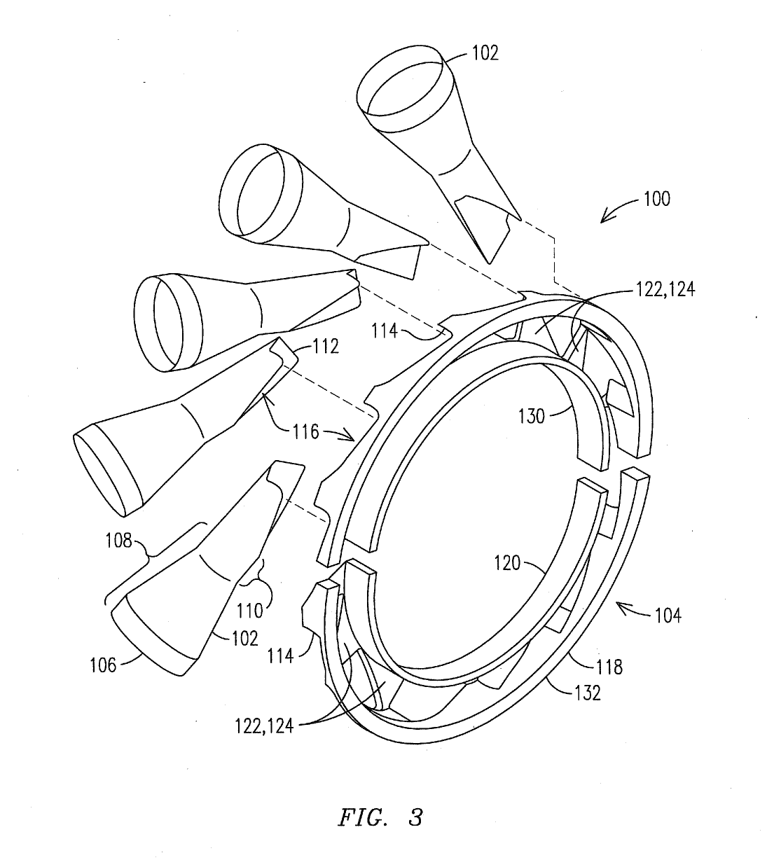

In the single piece embodiment of FIG. 2, maintenance to the hoop structure 104 that cannot be accomplished while the flow duct assembly 100 is in the gas turbine engine would require substantial effort, including removing all of the engine casing upper halves, lifting the rotor shaft, and removing other components from the rotor shaft in order to slide the unitary hoop structure 104 off the shaft for maintenance. However, in other embodiments, such as that shown in FIG. 3, the hoop structure 104 may be made of more than one hoop segment. For example, there may be two hoop segments 130, 132. In such an embodiment the two hoop segments may be joined using conventional joining techniques, but with only two places for joining the loss in strength would not be enough to render the design unsatisfactory. The aerodynamic inefficiency due to the two leakage paths would also not significantly reduce engine performance. However, losses and effort related to maintenance would be substantially reduced. In particular, with a two piece design only the combustor/mid engine casing may need to be removed, at which point one of the hoop segments could be lifted out, and then the second could be rotated around the rotor shaft and then be lifted out. In this manner the hoop structure 104 may be removed without the tremendous effort associated with lifting the rotor shaft out of place. These maintenance benefits greatly outweigh any losses that may occur by splitting a single piece hoop structure into two pieces. The embodiment of FIG. 3 shows two hoop segments. 130, 132, but more than two may be used as necessary. As the number of hoop segments increases so do the losses in strength and engine performance. However, so long as the number of hoop segments is not the same as the number of combustors, and in particular less than the number of combustors, then the losses are not as great as that of flow duct assemblies utilizing subassemblies 10.

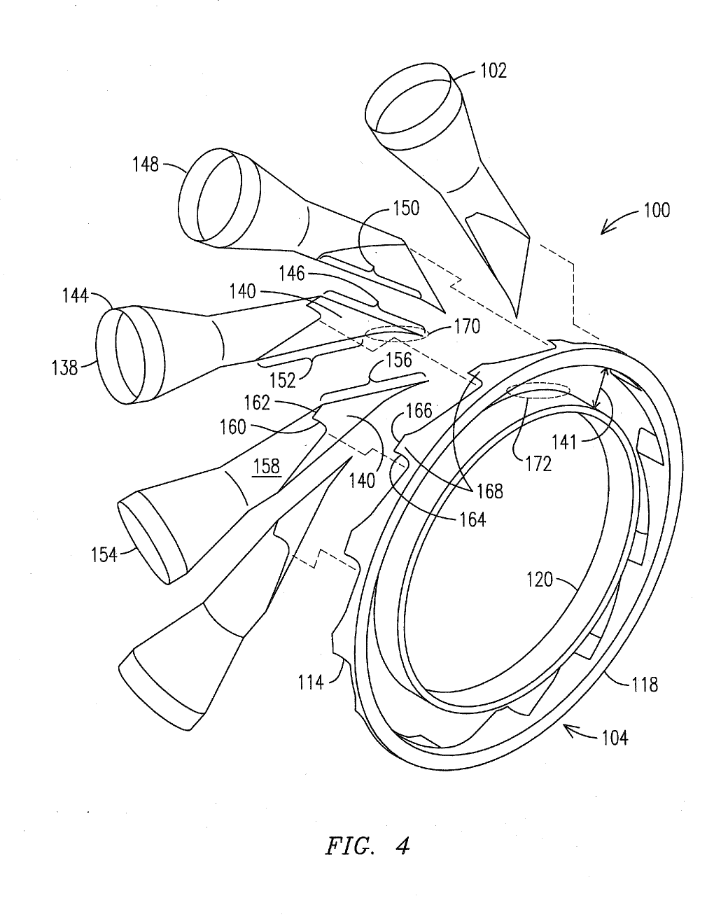

In an alternate embodiment, as opposed to the embodiment of FIGS. 2-3 where the radially outer wall 118 and the radially inner wall 120 are connected by the upstream wall segments 122, in the embodiment of FIG. 4 the radially outer wall 118 and the radially inner wall 120 are not directly connected to each other. Instead, an integrated inlet cone 138 has an integrated outlet 140 that serves at least two functions. Similar to the outlet 112 of the embodiment of FIGS. 2-3, the integrated outlet 140 delivers the combustion gas flow to the hoop structure 104. In addition, the integrated outlet 140 spans the gap 141 between the radially outer wall 118 and the radially inner wall 120, and secures the radially outer wall 118 and the radially inner wall 120. There are no upstream wall segments 122 between the integrated outlets 140 in this embodiment. By eliminating these upstream wall segments 122, the moment arm/cantilever effect of the conventionally joined flow duct assemblies brought about by the upstream wall segments 122, also present to a lesser degree in the embodiments of FIGS. 2-3, is essentially eliminated. The integrated outlets 140 themselves will span the radially outer wall 118 and the radially inner wall 120 and as a result there may still be some moment arm effect, but it is expected that it will be mitigated by a tolerance present in an integrated inlet cone/hoop structure joint 142 (indicated generally in FIG. 4 though the mating components are spaced apart). As a result, in this embodiment the pressure difference P1:P3 may be taken as more of a hoop stress within each of the radially outer wall 118 and the radially inner wall 120.

The integrated outlets 140 would not only span and secure the radially outer wall 118 and the radially inner wall 120 to each other, but without the intervening upstream wall segments 122, each integrated outlet 140 would also secure to circumferentially adjacent integrated outlets 140. For example, for a given integrated inlet cone 144, a circumferentially downstream edge 146 of the integrated outlet 140 of the given integrated inlet cone 144 secures to a circumferentially downstream adjacent integrated inlet cone 148 at a circumferentially upstream edge 150 of the integrated outlet 140 of the downstream adjacent integrated inlet cone 148. Likewise, a circumferentially upstream edge 152 of the integrated outlet 140 of the given integrated inlet cone 144 secures to a circumferentially upstream adjacent integrated inlet cone 154 at a circumferentially downstream edge 156 of the integrated outlet 140 of the upstream adjacent integrated inlet cone 154. In this manner when the integrated inlet cones 138 are fully assembled it can be envisioned that they form an assembly which is secured to the radially outer wall 118 and the radially inner wall 120.

In such an embodiment each integrated inlet cone outer wall 158 may have radially outer edges 160, 162 that may secure to edges 164, 166 (respectively) that are present on each outer wall segment base 168 remaining on the radially outer wall 118. At the integrated outlet 140 a radially inner side may have tapered to an integrated inlet cone radially inner edge 170, which may secure to an inner wall segment base region 172 present on the radially inner wall 120. As a result, since each integrated outlet 138 is secured circumferentially to each other, is secured on a radially outer side to the radially outer wall 118, and is secured on a radially inner side to the radial inner wall 120, the assembly is complete. Using the improved hoop design for the radially outer wall 118 and the radially inner wall 120 would provide improved support for the integrated outlets 140. Consequently there would still be an increase in mechanical strength and an increase in engine efficiency.

The particular geometry disclosed is only exemplary and other geometries may be used. Further, for each integrated inlet cone/hoop structure joint 142 there may be one or more than one way of joining each integrated inlet cone 138 to each of the walls 118, 120. For example, a combination of pins and/or bolts etc may be used for each integrated inlet cone/hoop structure joint 142. So long as in such an embodiment the walls 118, 120 are not secured to each other via upstream wall segments 122, the geometry and way of securing components together may be varied and still be within the scope of the invention.

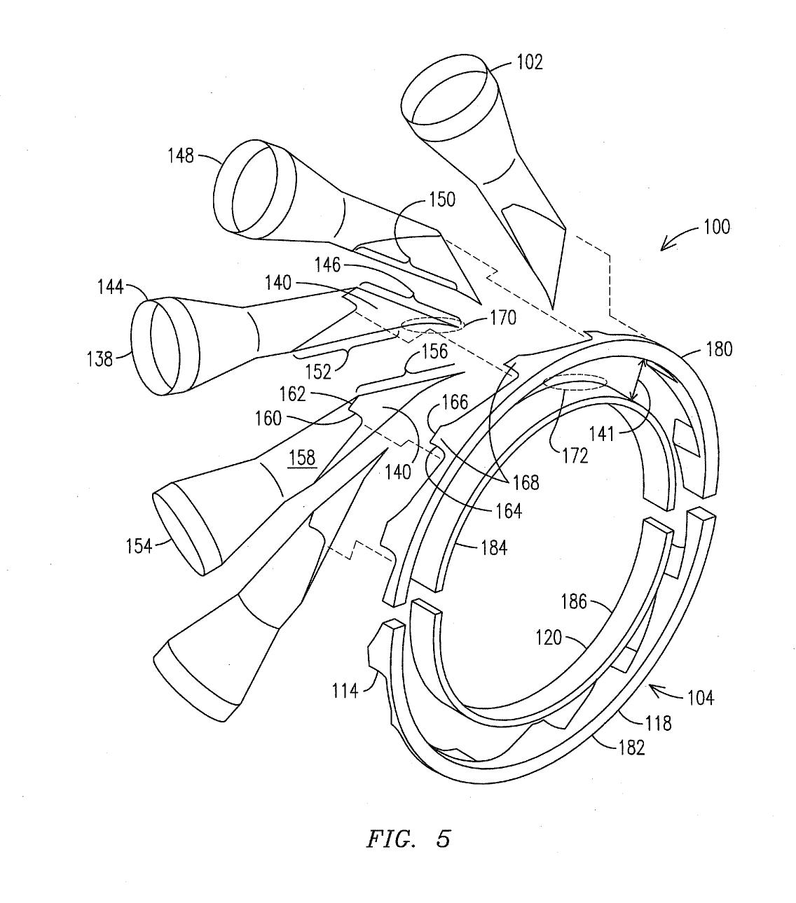

FIG. 5 shows the embodiment of FIG. 4, where the radially outer wall 118 and the radially inner wall 120 may themselves be made of two or more segments. For example, the radially outer wall 118 may be made of radially outer wall segments 180, 182. Likewise, the radially inner wall 120 may be made of radially inner wall segments 184, 186. Here again, in such an embodiment the wall segments may be joined using conventional joining techniques, but with only two places for joining the loss in strength would not be enough to render the design unsatisfactory. The aerodynamic inefficiency due to the two leakage paths would also not significantly reduce engine performance. However, losses and effort related to maintenance would be substantially reduced. More than two wall segments may be used as necessary. As the number of wall segments increases so do the losses in strength and engine performance. However, so long as the number of wall segments is not the same as the number of combustors, and in particular less than the number of combustors, then the losses are not as great as that of flow duct assemblies utilizing subassemblies 10.

Accordingly, it has been disclosed that the improved design of the hoop structure 104 of the flow duct assembly 100 provides for increased structural strength. This increased strength enables the hoop structure 104 to withstand the significantly increased mechanical brought about by pressure differences not present in gas turbine engines utilizing conventional transition ducts while decreasing the complexity of the support structure. The increased structural strength also increases the lifespan of the hoop structure 104, as well as the flow duct assembly 100, thereby decreasing a life-cycle-cost. The additional strength also allows for elimination of the thickened flanges associated with the flow duct systems employing subassemblies 10 and associated conventional joining techniques. Since the thickened flanges are more difficult to cool, this in turn permits more effective cooling, thereby increasing the flow duct system's 100 ability to handle the thermal loads generated by the combustion gases. In addition, in embodiments where the inner and outer walls are not connected by a wall segment, the hoop design better accommodates relative movement of the inner and outer walls resulting from thermal growth of the walls themselves and/or the support structures etc. This in turn reduces mechanical loads on the hoop structure and increases its lifespan. Further, the hoop design reduces manufacturing costs because the hoop design components are easier to manufacture, and it is easier to apply a TBC and perform associated laser drilling. In addition, elimination of a joint for every combustor decreases the number of leakage paths, which increases engine efficiency. Consequently, the hoop structure design represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. An arrangement for delivering combustions gas from a plurality of combustors onto a first row of turbine blades along respective straight gas flow paths, comprising:
a hoop structure at a downstream end of the arrangement and defining at least part of an annular chamber; and
a plurality of discrete ducts, each disposed between a respective combustor and the hoop structure, wherein each duct is secured to the hoop structure at a respective duct joint;
wherein the hoop structure comprises a quantity of hoop segments that is less than a quantity of ducts.

2. The arrangement of claim 1, wherein the hoop structure comprises a single, full-hoop segment.

3. The arrangement of claim 1, wherein the hoop structure comprises two semi-hoop segments.

4. The arrangement of claim 1, wherein the hoop structure comprises a radially inner wall, a radially outer wall, and upstream wall segments spanning there between.

5. The arrangement of claim 1, wherein the hoop structure comprises a discrete radially inner wall and a discrete radially outer wall secured to the ducts at the duct joints.

6. The arrangement of claim 1, wherein each of the plurality of discrete ducts comprises a throat region.

7. An arrangement for delivering combustions gas from a plurality of combustors onto a first row of turbine blades along respective straight gas flow paths, comprising:
an annular structure comprising a radially inner hoop wall and a radially outer hoop wall, the annular structure defining an annular chamber at a downstream end of the arrangement, wherein the inner hoop wall and the outer hoop wall each comprise a quantity of hoop segments that is less than a quantity of combustors, and
a plurality of discrete ducts, each disposed between a respective combustor and the hoop walls.

8. The arrangement of claim 7, wherein the plurality of discrete ducts are secured to an upstream hoop wall of the annular structure, wherein the upstream hoop wall spans between and secures the inner hoop wall and the outer hoop wall.

9. The arrangement of claim 8, wherein the annular structure comprises two or fewer hoop segments.

10. The arrangement of claim 7, wherein the inner hoop wall and the outer hoop wall are discrete components, and wherein the plurality of discrete ducts are secured to the inner hoop wall and the outer hoop wall.

11. The arrangement of claim 10, wherein the inner hoop wall and the outer hoop wall each comprise two or fewer hoop segments.

12. The arrangement of claim 7, wherein each of the plurality of discrete ducts comprises a throat region.

13. An arrangement for delivering combustions gas from a plurality of combustors onto a first row of turbine blades along respective straight gas flow paths, comprising:
an annular structure defining an annular chamber at a downstream end of the arrangement, the annular structure comprising two or fewer hoop segments; and
a plurality of discrete ducts, each extending from a respective combustor and in fluid communication with the annular structure.

14. The arrangement of claim 13, wherein the annular structure comprises a radially inner wall, a radially outer wall, and upstream wall segments spanning there between, and wherein the plurality of discrete ducts are secured to the annular structure at respective joints.

15. The arrangement of claim 13, wherein the annular structure comprises a discrete radially inner wall and a discrete radially outer wall secured to downstream ends of the ducts.

16. The arrangement of claim 13, wherein each of the plurality of discrete ducts comprises a throat region.
